(19) United States
(12) Patent Application Publication
(10) Pub. No.: US 2026/0032482 A1
(43) Pub. Date: Jan. 29, 2026

(54) REPORTING PREDICTED REFERENCE SIGNAL RECEIVED POWER (RSRP) IN THE TEMPORAL DOMAIN

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Prasanna Herath, Laval (CA); Shahab Hamidi-Rad, Sunnyvale, CA (US); Nazli Khan Beigi, Longueuil (CA); Oumer Teyeb, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 18/787,031

(22) Filed: Jul. 29, 2024

(51) Int. Cl. H04W 24/10; H04B 1/40; H04B 17/309; H04B 17/373

(52) U.S. Cl. CPC H04W 24/10; H04B 1/40; H04B 17/309; H04B 17/373

(57) ABSTRACT

Beams may be predicted. One or more beams may be determined to be the best beams among a set of beams. For example, in downlink (DL) Transmit ( ) Tx beam prediction, reference signals (RSs) for selected beams may be transmitted and qualities of other beams may be estimated based on measurements of the selected beams. Best beams may be determined based on measured beams, unmeasured beams, or any appropriate combination thereof. Reference signal received power (RSRP) may be used to predict best beams.

### BACKGROUND

In traditional beam management procedures, all the beams in a cell are transmitted to a wireless transmit/receive unit (WTRU) and measured by the WTRU to identify a best beam. This process may be time consuming and utilize excessive resources. Reporting of the process and its results also may be time consuming and utilize excessive resources.

### SUMMARY

As described herein, beams may be predicted and reported. One or more beams may be predicted to be the best beams among a set of beams. A wireless transmit/receive unit (WTRU), a network node (e.g., gNB), or the like may predict one or more best beams out of possible beams including beams for which aspects may have been measured and beams for which aspects may not have been measured. Various techniques may be utilized to predict best beams. Artificial intelligence (AI) and/or machine learning (ML) may be used to predict best beams. Best beams may be predicted based on measured beams, unmeasured beams, or any appropriate combination thereof. Any appropriate aspect, or aspects, of a beam may be used to predict best beams. For example, reference signal received power (RSRP) may be used to predict best beams. Any appropriate measure of performance may be used to predict best beams. Best beams may be reported by a WTRU to a network.

An example WTRU for predicting beams may comprise a transceiver and a processor. The processor may be configured to receive, via the transceiver, configuration information. The configuration information may comprise an indication of a first set of beams and an indication of a second set of beams. The second set of beams may be a subset of the first set of beams. The configuration information may comprise an indication of a set of RS resources associated with the second set of beams. The configuration information may comprise an indication of one or more beam quality thresholds. The processor may be configured to determine a measured beam quality associated with at least one beam of the second set of beams based on measurements performed on the set of RS resources associated with the second set of beams. The processor may be configured to determine, for at least one future time instance, a predicted beam quality associated with at least one beam of the first set of beams based on the measured beam quality associated with the at least one beam of the second set of beams. The processor may be configured to send, via the transceiver, a report, wherein content of the report is based on the predicted beam quality associated with the at least one beam of the first set of beams for the at least one future time instance and the received one or more beam quality thresholds. The measured beam quality associated with the at least one beam of the second set of beams may be associated with a first time instance and the predicted beam quality associated with the at least one beam of the first set of beams may be associated a future time instance the is subsequent in time to the first time instance. The measured beam quality associated with the at least one beam of the second set of beams may comprise at least one of reference signal received power (RSRP), signal to interference plus noise ratio (SINR), or noise power, and wherein the predicted beam quality associated with the at least one beam of the first set of beams may comprise at least one of reference signal received power (RSRP), signal to interference plus noise ratio (SINR), or noise power. The content of the report may comprise, for each future time instance of the at least one future time instance, an indication of selected beams of the first set of beams, wherein the selected beams associated with each future time instance are indicated for each future time instance in a sequence of future time instances, and wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for each future time instance of the at least one future time instance, an indication of selected beams of the first set of beams, wherein the selected beams are indicated in order of beam quality associated with the selected beams, and wherein the selected beams are selected based on the predicted beam quality associated with each beam of the first set of beams and the one or more beam quality thresholds. The content of the report further may comprise an indication of the predicted beam quality associated with each selected beam of the first set of beams. The report may comprise a bitmap for identifying an association between each future time instance and each selected beams of the first set of beams. The content of the report may comprise, for each future time instance of the at least one future time instance, an indication of a selected beam associated with each future time instance, wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for a first future time instance of the at least one future time instance, an indication of a selected beam of the first set of beams and an indication of the predicted beam quality associated with the selected beam, and for each future time instance other than the first future instance, an indication of a difference between the predicted beam quality associated with the selected beam for the first future time instance and the predicted beam quality associated with the selected beam associated with each respective other future time instance. The content of the report may comprise an indication of a first beam of the first set of beams, and for each future time instance of the at least one future time instance, an indication of selected beams of the first set of beams.

An example method for predicting beams may be performed by a WTRU. The method may comprise receiving configuration information. The configuration information may comprise an indication of a first set of beams and an indication of a second set of beams. The second set of beams may be a subset of the first set of beams. The configuration information may comprise an indication of a set of RS resources associated with the second set of beams. The configuration information may comprise an indication of one or more beam quality thresholds. The method may comprise determining a measured beam quality associated with at least one beam of the second set of beams based on measurements performed on the set of RS resources associated with the second set of beams. The method may comprise determining, for at least one future time instance, a predicted beam quality associated with at least one beam of the first set of beams based on the measured beam quality associated with the at least one beam of the second set of beams. The method may comprise sending a report, wherein content of the report is based on the predicted beam quality associated with the at least one beam of the first set of beams for the at least one future time instance and the received one or more beam quality thresholds. The measured beam quality associated with the at least one beam of the second set of beams may be associated with a first time instance and the predicted beam quality associated with the at least one beam of the first set of beams may be associated a future time instance the is subsequent in time to the first time instance. The measured beam quality associated with the at least one beam of the second set of beams may comprise at least one of reference signal received power (RSRP), signal to interference plus noise ratio (SINR), or noise power, and wherein the predicted beam quality associated with the at least one beam of the first set of beams may comprise at least one of reference signal received power (RSRP), signal to interference plus noise ratio (SINR), or noise power. The content of the report may comprise, for each future time instance of the at least one future time instance, an indication of selected beams of the first set of beams, wherein the selected beams associated with each future time instance are indicated for each future time instance in a sequence of future time instances, and wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for each future time instance of the at least one future time instance, an indication of selected beams of the first set of beams, wherein the selected beams are indicated in order of beam quality associated with the selected beams, and wherein the selected beams are selected based on the predicted beam quality associated with each beam of the first set of beams and the one or more beam quality thresholds. The content of the report further may comprise an indication of the predicted beam quality associated with each selected beam of the first set of beams. The report may comprise a bitmap for identifying an association between each future time instance and each selected beams of the first set of beams. The content of the report may comprise, for each future time instance of the at least one future time instance, an indication of a selected beam associated with each future time instance, wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for a first future time instance of the at least one future time instance, an indication of a selected beam of the first set of beams and an indication of the predicted beam quality associated with the selected beam, and for each future time instance other than the first future instance, an indication of a difference between the predicted beam quality associated with the selected beam for the first future time instance and the predicted beam quality associated with the selected beam associated with each respective other future time instance. The content of the report may comprise an indication of a first beam of the first set of beams, and for each future time instance of the at least one future time instance, an indication of selected beams of the first set of beams.

At least one example non-transitory computer-readable storage medium may comprise executable instructions for configuring at least one processor to predict beams. The executable instructions may configure at least one processor to receive configuration information. The configuration information may comprise an indication of a first set of beams and an indication of a second set of beams. The second set of beams may be a subset of the first set of beams. The configuration information may comprise an indication of a set of RS resources associated with the second set of beams. The configuration information may comprise an indication of one or more beam quality thresholds. The executable instructions may configure the at least one processor to determine a measured beam quality associated with at least one beam of the second set of beams based on measurements performed on the set of RS resources associated with the second set of beams. The executable instructions may configure the at least one processor to determine, for at least one future time instance, a predicted beam quality associated with at least one beam of the first set of beams based on the measured beam quality associated with the at least one beam of the second set of beams. The executable instructions may configure the at least one processor to send a report, wherein content of the report is based on the predicted beam quality associated with the at least one beam of the first set of beams for the at least one future time instance and the received one or more beam quality thresholds. The measured beam quality associated with the at least one beam of the second set of beams may be associated with a first time instance and the predicted beam quality associated with the at least one beam of the first set of beams may be associated a future time instance the is subsequent in time to the first time instance. The measured beam quality associated with the at least one beam of the second set of beams may comprise at least one of reference signal received power (RSRP), signal to interference plus noise ratio (SINR), or noise power, and wherein the predicted beam quality associated with the at least one beam of the first set of beams may comprise at least one of reference signal received power (RSRP), signal to interference plus noise ratio (SINR), or noise power. The content of the report may comprise, for each future time instance of the at least one future time instance, an indication of selected beams of the first set of beams, wherein the selected beams associated with each future time instance are indicated for each future time instance in a sequence of future time instances, and wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for each future time instance of the at least one future time instance, an indication of selected beams of the first set of beams, wherein the selected beams are indicated in order of beam quality associated with the selected beams, and wherein the selected beams are selected based on the predicted beam quality associated with each beam of the first set of beams and the one or more beam quality thresholds. The content of the report further may comprise an indication of the predicted beam quality associated with each selected beam of the first set of beams. The report may comprise a bitmap for identifying an association between each future time instance and each selected beams of the first set of beams. The content of the report may comprise, for each future time instance of the at least one future time instance, an indication of a selected beam associated with each future time instance, wherein the selected beams are selected based on the predicted beam quality associated with each beam of the first set of beams and the one or more beam quality thresholds. The content of the report further may comprise an indication of the predicted beam quality associated with each selected beam. The content of the report may comprise, for a first future time instance of the at least one future time instance, an indication of a selected beam of the first set of beams and an indication of the predicted beam quality associated with the selected beam, and for each future time instance other than the first future instance, an indication of a difference between the predicted beam quality associated with the selected beam for the first future time instance and the predicted beam quality associated with the selected beam associated with each respective other future time instance. The content of the report may comprise an indication of a first beam of the first set of beams, and for each future time instance of the at least one future time instance, an indication of selected beams of the first set of beams.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example format of the report that a wireless transmit/receive unit (WTRU) may use to report temporally predicted future beams and their reference signal received power (RSRP) values.

### DETAILED DESCRIPTION

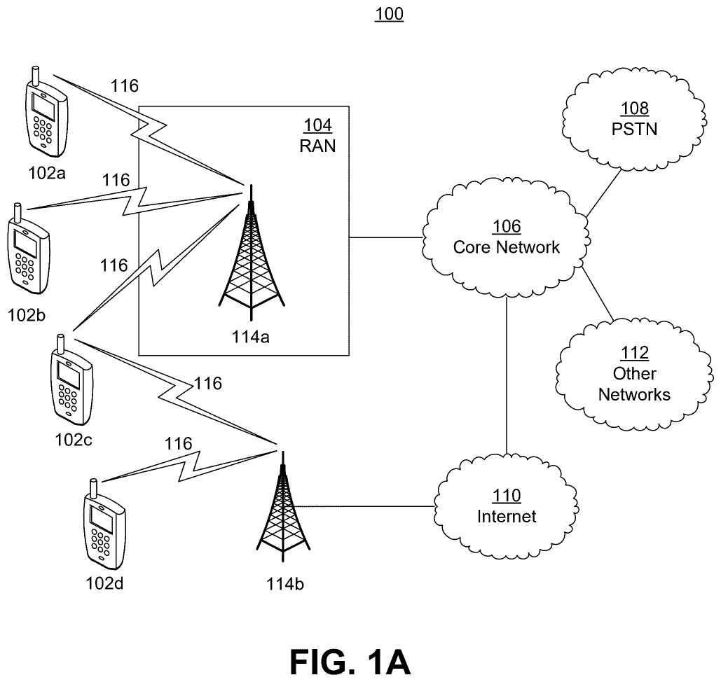

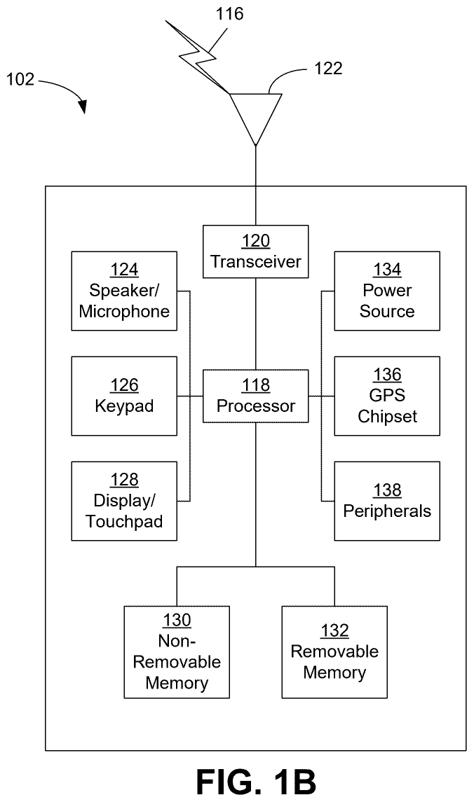

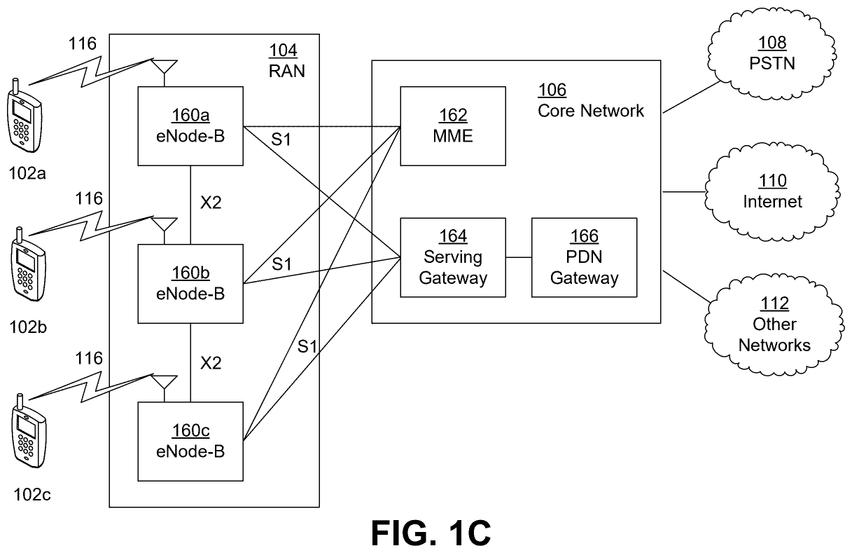

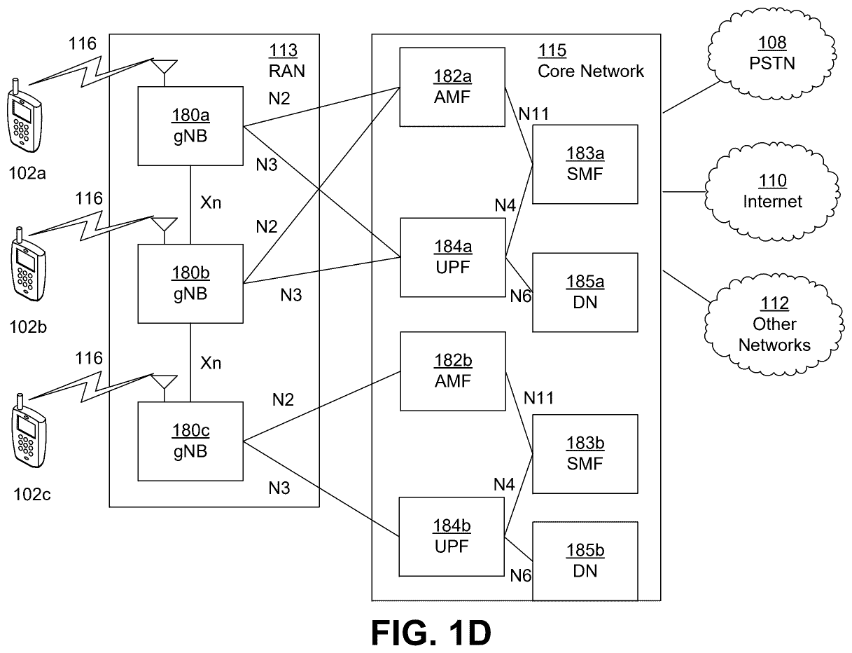

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Apparatuses and methods for predicting and reporting beams are described herein. Reference signals (RSs) for selected beams may be utilized to predicted beams (e.g., best beams). Best beams may include beams other than the selected beams. AI and/or ML (AI/ML) models may be used to predict best beams. For example, in AI/ML-based downlink (DL) transmit (Tx) beam prediction, RSs for selected beams may be transmitted and an AI/ML model, or models, may be used to estimate/predict qualities of other beams based on measurements of the selected beams. This may result in improving performance and complexity in conventional beam management aspects, including beam prediction in time, and/or spatial domain for overhead and latency reduction, beam selection accuracy improvement, or the like.

Predicting one or more best beams among a set of beams may result in beam management procedures that are more accurate and utilize less overhead than legacy beam management procedures. AI/ML may be used with respect to beam management. AI/ML may be used with respect to beam management to predict qualities of beams including unmeasured beams based on the measured qualities of beams. In contrast to measuring RS signals associated with a beam by a WTRU to determine the beam quality and reporting best beam(s) among the measured beams, an AI/ML model in a WTRU (or network node such as a gNB) may predict one or more beams out of all possible beams including those not measured by the WTRU (or network node/gNB).

Any appropriate mechanism may be utilized to predict beams. For example, an AI/ML model may be utilized to predict beam qualities of unmeasured beams. An AI/ML model may facilitate making multiple temporal predictions for different time instances in the future based on current RS measurements. The input to the AI/ML may be a set of beam measurements associated with a set of reference signals (RSs). The input set may be denoted by Set B. The AI/ML model may predict a best beam (e.g., a beam index) and/or qualities of beams from an output predicted set of beams, denoted by Set A. Set B may be a subset of Set A. An AI/ML model may make multiple temporal predictions for different time instances in the future based on current RS measurements. A WTRU may report any appropriate number of beams and associated beam qualities based on latest/recent measurements by the WTRU. For example, a WTRU may report predicted beams and predicted reference signal received power (RSRP) values for multiple future time instances in one report.

As explained in more detail herein, a WTRU may receive a configuration for RSs associated with a measurement set, a prediction set, and WTRU reporting. Based on RS measurements, the WTRU may temporally predict beams and RSRPs. The WTRU may determine reporting parameters (e.g., number of prediction instances, number of beams and associated RSRPs) based on received configuration, predicted RSRPs, WTRU measurements and thresholds. The WTRU may select a method for reporting based on received configuration and WTRU measurements. The WTRU may report predicted beams and RSRPs for multiple prediction instances using the selected method and determined report parameters. This process may enable the WTRU to support reporting mechanisms for temporal beam and beam quality predictions made by the WTRU. Moreover, beam configuration latency may be reduced at the network since the network obtains information on future beams in advance in a single report.

A WTRU may receive a configuration associated with predicting beams. The configuration received by the WTRU may comprise any appropriate information. For example, the received configuration may comprise an RS resource set containing RS resource configurations for both Set A and Set B. The configuration may comprise an indication of Set A/Set B resources. The received configuration may comprise two or more RS resource sets associated with Set A and Set B(s). The received configuration may comprise thresholds (e.g., a threshold for number of beams, an RSRP threshold, RSRP difference threshold, a threshold for WTRU speed, a threshold for line of sight-LOS probability, etc.). The received configuration may comprise information associated with a report, such as, maximum payload size (M), a number of future time instances (N), a number of beams (K), time gap(s) in temporal predictions report in the WTRU report. The received configuration may comprise any appropriate combination of the above-described information.

The WTRU may perform measurements on RSs associated with Set B and/or Set A. The WTRU may determine measured beam qualities, such as, for example, RSRP, signal to interference plus noise ratio (SINR), noise power, etc., based on RS measurements. The WTRU may predict one or more of the following based on RS measurements associated with Set B. The WTRU may predict the Top-K_max spatially predicted beams and/or RSRPs, where the Top-K_max spatially predicted beams are the K_max spatially predicted beams in Set A with highest predicted RSRP values in a first time instance. The WTRU may predict the Top-K_max temporally predicted beams and/or RSRPs for one or more future time instances (e.g., for one or more slots/frames etc.), where the Top-K_max temporally predicted beams are the K_max temporally predicted beams in Set A with highest predicted RSRP value in one or more future time instances.

The WTRU may determine a value of N and a number of beams per time instance, denoted by K_n (where n=1, 2, . . . . N) based on the received configuration and thresholds (e.g., K_n is equal to Number of predicted RSRPs>RSRP threshold per time instance n, and the value of K_n is upper bounded by M/N and K_max, and N is received in the configuration).

The WTRU may use any appropriate reporting method. A reporting method may be based on, for example, measurements, determined values of N and K_n, and/or thresholds. In a first method (Method 1), a WTRU may report Top-K_n predicted beams and/or RSRPs per time instance (e.g., from the Top-K_max temporally predicted beams and/or RSRPs) for N future instances in one report in a sequence. The WTRU may report the predicted beams for each reporting instance in the order of expected performance (e.g., order of predicted RSRPs). The WTRU may report the K_n values. For example, the total number of beams reported may be equal to the sum of Top-K_n over all N.

In a second method (Method 2), a WTRU may report Top-K_n predicted beams and/or RSRPs per time instance (e.g., from the Top-K_max temporally predicted beams and/or RSRPs) for N future instances in a set. The WTRU may report the beams in order of performance/predicted RSRPs. The WTRU may indicate a value of N (e.g., if determined by WTRU). The WTRU my report one or more (e.g., N) bitmap(s) to identify a time instance for each reported predicted beam and/or RSRP.

In a third method (Method 3), a WTRU may determine a single set of K_n (e.g., n=1) of predicted beams to report applicable to every N future time instance based on predicted RSRPs of beams (e.g., average, weighted and/or instantaneous predicted RSRP). The WTRU may indicate a determined set of K_n predicted beams to the network node (e.g., gNB) and predicted RSRPs associated to reported beams. For example, the total number of beams reported may be equal to K_1 times N.

In a fourth method (Method 4), a WTRU may report the best (e.g., Top-1) beam for each time instance. The WTRU may report the predicted RSRP (e.g., absolute) of the Top-1 beam for the first time instance. The WTRU may report differential (e.g., both positive and negative) predicted RSRPs associated to reported beams for the subsequent N−1 time instances.

A WTRU may report a spatial and temporal combined report. The WTRU may report the Top-K_1 spatially predicted beams and/or RSRPs in the first time instance. The WTRU may report the Top-K_n temporally predicted beams and/or RSRPs for the remaining/other N−1 time instances.

A WTRU may report feedback using the determined reporting method. The WTRU may indicate the determined reporting method and/or measurements used to determine the reporting method.

Regarding terminology used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

Artificial intelligence may be broadly defined as the behavior exhibited by machines. Such behavior may e.g., mimic cognitive functions to sense, reason, adapt and act. Machine learning may refer to type of algorithms that solve a problem based on learning through experience (‘data’), without explicitly being programmed (‘configuring set of rules’).

Machine learning may be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data.

Deep learning refers to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AI/ML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

A WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

Hereafter, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this invention.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following.

The CSI may be configured with a CSI Report Configuration comprising one or more of a CSI report quantity, e.g., Channel Quality Indicator (CQI), Rank Indicator (RI), Precoding Matrix Indicator (PMI), CSI-RS Resource Indicator (CRI), Layer Indicator (LI), etc., CSI report type, e.g., aperiodic, semi persistent, periodic, CSI report codebook configuration, e.g., Type I, Type II, Type II port selection, etc., or a CSI report frequency.

The CSI may be configured with a CSI Resource Set comprising one or more of the following CSI Resource settings: a non-zero-power (NZP)-CSI-RS Resource for channel measurement, an NZP-CSI-RS Resource for interference measurement, or a CSI-interference measurement (IM) Resource for interference measurement.

The CSI may be configured with a CSI Resource Set comprising one or more of an NXP-CSI-RS Resource identifier (ID), a periodicity and offset, QCL information and TCI state, or a resource mapping, such as, for example, a number of ports, density, code division multiplexing (CDM) type, etc.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

Synchronization signal (SS) reference signal received power (RSRP) (SS-RSRP) may be measured based on the synchronization signals (e.g., demodulation reference signal (DMRS) in PBCH or SSS-secondary synchronization signal). It may be defined as the linear average over the power contribution of the resource elements (RE) that carry the respective synchronization signal. In measuring the RSRP, power scaling for the reference signals may be required. In case SS-RSRP is used for layer 1 (L1)-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).

Sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single BWP (e.g., indicated by BWP-Id), wherein one or more of the following parameters are configured: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; Time restrictions for channel and interference measurements; Report frequency band configuration (wideband/subband CQI, PMI, and so forth); Thresholds and modes of calculations for the reporting quantities (CQI, RSRP, SINR, LI, RI, etc.); Codebook configuration; Group based beam reporting; CQI table; Subband size; Non-PMI port indication; Port Index; or the like, or any appropriated combination thereof.

A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; The bandwidth part to which the configured CSI-RS is allocated; The reference to the TCI-State including the QCL source RS(s) and the corresponding QCL type(s); or any appropriate combination thereof.

One or more of following configurations may be used for RS resource set. A WTRU may be configured with one or more RS resource sets. The RS resource set configuration may include one or more of a RS resource set ID, one or more RS resources for the RS resource set, repetition (e.g., on or off), aperiodic triggering offset (e.g., one of 0-6 slots), or TRS info (e.g., true or not).

One or more of following configurations may be used for RS resource. A WTRU may be configured with one or more RS resources, such as, for example, an RS resource ID, a resource mapping (e.g., Res in a PRB), a power control offset (e.g., one value of −8, . . . , 15), a power control offset with SS (e.g., −3 dB, 0 dB, 3 dB, 6 dB), a scrambling ID, a periodicity and offset, or QCL information (e.g., based on a TCI state).

In the following, a property of a grant or assignment may consist of at least one of the following: a frequency allocation; an aspect of time allocation, such as a duration; a priority; a modulation and coding scheme; a transport block size; a number of spatial layers; a number of transports blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; A configured grant index or a semi-persistent assignment index; a periodicity of a configured grant or assignment; a channel access priority class (CAPC); or any parameter provided in a DCI, by MAC or by RRC for the scheduling the grant or assignment.

In the following, an indication by DCI may comprise at least one of the following: an explicit indication by a DCI field or by RNTI used to mask CRC of the PDCCH; or an implicit indication by a property such as DCI format, DCI size, Coreset or search space, Aggregation Level, first resource element of the received DCI (e.g., index of first Control Channel Element), where the mapping between the property and the value may be signaled by RRC or MAC. Hereafter, RS may be interchangeably used with one or more of RS resource, RS resource set, RS port and RS port group, but still consistent with this invention. Hereafter, RS may be interchangeably used with one or more of SSB, CSI-RS, SRS, DM-RS, TRS, PRS, and PTRS, but still consistent with this invention.

Hereafter, a reference signal may be interchangeably used with one or more of following: sounding reference signal (SRS); channel state information-reference signal (CSI-RS); demodulation reference signal (DM-RS); phase tracking reference signal (PT-RS); or synchronization signal block (SSB); but still consistent with this invention.

Hereafter, a channel may be interchangeably used with one or more of following: PDCCH; PDSCH; physical uplink control channel (PUCCH); physical uplink shared channel (PUSCH); physical random access channel (PRACH); or the like; but still consistent with this invention.

A key performance indicator (KPI) may refer to, but not limited to, one or more of the following: Signal quality (e.g., L1-RSRP, SINR, CQI, RSSI, RSRQ); prediction performance (e.g., Percentage of the Top-1 genie-aided (i.e., best) beam is one of the Top-K predicted beams); link quality (e.g., throughput, block error rate (BLER)); data distribution (e.g., mean and/or variance of measured and/or predicted beam measurements); or RSRP (e.g., L1-RSRP) difference (i.e., the difference between measured and predicted RSRP of a beam).

Hereafter, a signal, channel, and message (e.g., as in DL or UL signal, channel, and message) may be used interchangeably, but still consistent with this invention. Hereafter, a RS resource set may be interchangeably used with a RS resource and a beam group, but still consistent with this invention. Hereafter, beam reporting may be interchangeably used with CSI measurement, CSI reporting and beam measurement, but still consistent with this invention. Hereafter, the proposed solutions for beam resources prediction may be used for beam resources belonging to a single or multiple cells as well as single or multiple TRPs, and still consistent with this invention. Hereafter, CSI reporting may be interchangeably used with CSI measurement, beam reporting and beam measurement, but still consistent with this invention. Hereafter, a RS resource set may be interchangeably used with a beam group, but still consistent with this invention. Hereafter, a Set B may be interchangeably used with a set of—RS resource sets, beams, beam-pairs, beam RS resources, RS resources and a beam pattern. Hereafter, Set B may be interchangeably used with measurement RS resources, measurement RS resource set, measurement beam resources, measurement beam resource set, measurement beam pattern, measurement TCI states, measurement TCI state group and etc., but still consistent with this invention. Hereafter, a Set A may be interchangeably used with a set of—RS resource sets, beams, beam-pairs, beam RS resources, RS resources, and a beam pattern. Hereafter beam prediction accuracy may be interchangeably used with prediction accuracy, but still consistent with the solution.

A WTRU may be configured with measurement resources and parameters for predicting best beams. A WTRU may be configured via any appropriate manner, such as, for example, via radio resource control (RRC), via medium access control (MAC) control element (CE), via downlink control information (DCI), or the like. A WTRU may be configured with one or more of the following. A WTRU may be configured with one RS resource set wherein one or more RS resources associated with the RS resource set may be associated to one or more of Set B, Set A and/or neither (e.g., not with Set A or Set B). The association of an RS resource with Set B and/or Set A may be configured via RRC (e.g., via one or more parameters inside RS-ResourceConfig and/or RS-ResourceSetConfig), MAC-CE, and/or DCI (e.g., a bitmap-based activation/indication of association of RS resources with Set B and/or Set A).

A WTRU may be configured with Two or more RS resource Sets wherein each RS resource set is associated to either Set B or Set A.

A WTRU may be configured with one or more thresholds, such as, for example, a threshold for number of beams, a threshold for beam quality (e.g., RSRP threshold), a threshold for difference between beam quality (e.g., RSRP difference threshold), a threshold for WTRU speed, a threshold for LOS probability.

A WTRU may be configured with one or more CSI/Beam-Report configurations. A CSI/Beam-Report configuration may comprise payload size configuration. The WTRU may receive a configuration of one or more of the following parameters: a max payload size (e.g., total number of beams/beam qualities [e.g., RSRPs] reported in one reported), denoted by M; a number of temporal prediction instances, denoted by N, to be reported in one report; one or more N values; a number of beams/beam qualities, denoted by K, to be reported per prediction instance in one report; one or more K values; or the like, or any appropriate combination thereof.

A WTRU may be configured with time configurations. The WTRU may receive a configuration of time gap (e.g., ms, slots, frames) between future temporal predictions (e.g., time gap between applicability of temporal predictions) to be reported in one report. The WTRU may report predictions (e.g., predicted beams/RSRPs) based on the configured time gap.

A WTRU may determine a time gap between multiple prediction instances based on RS resource configuration (e.g., a multiple of periodicity of RS resources). A WTRU determine time gap based on a configured accuracy threshold (e.g., based on accuracy of WTRU prediction>threshold).

A WTRU may be configured with one or more resources for a correction report. For example, a WTRU may receive a configuration of resources for a correction report with a different (e.g., shorter) periodicity than a CSI-Report.

A WTRU may perform measurements on RSs associated with Set B and/or Set A. Based on the measurements, the WTRU may determine measured beam qualities (e.g., RSRP, noise power) of measured RSs associated to Set B and/or Set A. Based on the measurements associated with beams/RSs associated to Set B, the WTRU may determine one or more of the following. A WTRU may determine predicted best beams (e.g., beams with highest RSRP). A WTRU may perform one or more temporal and/or spatial predictions of beam indices of Top-Kmax highest quality beams. A WTRU may determine predicted qualities (e.g., RSRPs). A WTRU may perform one or more (e.g., Top-Kmax) temporal and/or spatial predictions of RSRPs of beams associated with Set A (e.g., also including Set B). A predicted beam quality/predicted RSRP may refer to a beam quality/RSRP associated with a beam, not obtained by directly measuring the RS associated with a beam (e.g., obtained by an AI/ML model and/or through other filtering/signal processing techniques performed on RS measurements by the WTRU).

Reporting parameters may be determined. A WTRU may receive a configuration of a payload size (e.g., max payload), denoted by M. For example, the WTRU may be configured to report a max M number of predicted and/or measured beams and/or beam qualities (e.g., RSRPs, CQI, SINR). A WTRU may be configured/indicated and/or determine one or more of the following reporting parameters (e.g., via a CSI-Report): a number of temporal (e.g., future) prediction instances, denoted by N, for which beam/CSI information may be reported in one report by the WTRU; or a number of beams/beam qualities, denoted by K, reported as part of beam/CSI information in one report. A WTRU may be configured and/or determine a K value applicable to all reported prediction instances. A WTRU may be configured and/or determine a separate K value for each prediction instance (e.g., K_1, K_2, K_3, . . . , K_N). Per instance number of beams may be denoted by K_n, where n=1, 2, . . . , N. The parameter K may interchangeably be used with K_n but still consistent with the invention. In an example configuration, the payload size may not exceed the configured payload size, M. A WTRU may determine N and/or K such that the product N×K is less than or equal to M (e.g., the payload associated with N×K is less than or equal to the maximum payload, M). A WTRU may determine a separate K value for each reported prediction instance, the sum of all reported beams/beam qualities for each prediction instance K_n (i.e., K_1+K_2+K_3, . . . . K_N) may be less than or equal to M.

A WTRU may be indicated a value for K and/or N. A WTRU may determine one parameter (e.g., K or N) based on the other indicated parameters. For example, the WTRU may determine K=M/N when both M and N are indicated. For example, the WTRU may determine N=M/K when both K and N are indicated.

A WTRU may determine one or more K values in one or more of the following ways. A WTRU may determine one or more K values based on predicted qualities (e.g., RSRPs) of beams. A WTRU may determine a K value equal to the number of predicted qualities>a beam quality threshold. A WTRU may determine a K value equal to the number of predicted beam qualities whose difference with the highest beam quality<a beam quality difference threshold. The K value may be upper bounded by M (e.g., when N=1 and/or when N is determined by the WTRU after the determination of K) or M/N (e.g., when N is configured or determined before determination K or when N=1). The WTRU may determine separate K_n values for each reported prediction instance (e.g., when N is configured, known, and/or determined by the WTRU) based on, for example, when WTRU speed (e.g., when the WTRU is in motion)>speed threshold. The WTRU may select a smaller K for prediction instances farther in future. For example, the WTRU may select a K_1 value for the first prediction instance and a K_2 value for the second prediction instance, where K_1 may be greater than K_2. A WTRU may determine a fixed K value applicable to all reported prediction instances.

A WTRU may determine a fixed K value applicable to all prediction instances in the report as follows. A WTRU may determine a K value based on predicted qualities (e.g., RSRPs) of a first prediction instance. A WTRU may apply/use the determined K value for the report of all prediction instances. A WTRU may determine a separate K value for each prediction instance and determine an average of the K values. A WTRU may apply/use of the determined K value for the report of all prediction instances.

A WTRU may determine the N value in one or more of the following ways. A WTRU may determine the N value based on a determined K: A WTRU may determine the N value equal to M/K (e.g., floor/round down value of M/K). A WTRU may select the highest N value, less than or equal to M/K out of pre-configured N values. A WTRU may determine the N value based on WTRU speed: A WTRU may determine the N value equal to 1 based on the condition that WTRU speed>a speed threshold. A WTRU may determine the N value based on the WTRU's confidence in a prediction: The WTRU may select a first N value if the WTRU's confidence and/or prediction accuracy>confidence threshold, otherwise the WTRU may select a second N value where first N value>second N value. A WTRU may determine the N value based on LOS probability. A WTRU may select a first N value if at least one measured beam/RS's line of sight (LOS) probability>LOS probability threshold, otherwise the WTRU may select a second N value where first N value>second N value.

Reporting methods may be determined. A WTRU may determine a reporting method (e.g., Method 1: WTRU Reports Predicted beams and Predicted RSRPs in a Sequence, Method 2: WTRU Reports Predicted beams and Predicted RSRPs and indicates beams/RSRPs for each instance using bitmap; Method 3: WTRU may report a set of predicted beams and RSRPs and future time instance predicted RSRPs associated with the reported beams, etc.) based on one or more of the following. A reporting method may be based on a network node, such as a gNB, provided indication/configuration. For example, a WTRU may determine a reporting method based on an indication/configuration received from a network node, such as a gNB, or the like (e.g., via RRC signaling, MAC-CE indication, DCI indication).

A reporting method may be based on RS (e.g., CSI-RS, SSB) resource set associated with Set A/Set B. For example, a reporting method may be a property of a RS resource set of Set A/Set B. A WTRU may determine the reporting method based on the reporting method associated with the configured/indicated Set A/Set B RS resources set.

A reporting method may be based on report configuration (e.g., reportConfigType). For example, a WTRU may use a 1^{st} method for beam reporting if report configuration is of aperiodic type. A WTRU may use a 2^{nd} method for beam reporting if reporting configuration is of semi persistent type.

A reporting method may be based on uplink (UL) resources (e.g., PUSCH/PUCCH) configured/indicated for transmitting beam report. For example, a WTRU may determine to use a 1^{st} reporting method if UL resources configured/indicated for beam reporting is 1^{st} type (e.g., PUCCH). A WTRU may determine to use a 2^{nd} reporting method if UL resources configured/indicated for beam reporting is 2^{nd} type (e.g., PUSCH).

A reporting method may be based on speed of a WTRU and a preconfigured speed-related threshold. For example, if the speed of a WTRU is lower than or equal to a preconfigured (e.g., via RRC signaling, MAC-CE indication, DCI indication) threshold, the WTRU may determine to use a 1^{st} reporting method. If the speed of a WTRU is higher than a preconfigured threshold, the WTRU may determine to use a 2^{nd} reporting method. A WTRU may use a measurement associated with the speed of the WTRU. For example, if the doppler shift measured by the WTRU is lower than or equal to a preconfigured (e.g., preconfigured via RRC signaling, MAC-CE indication, DCI indication) threshold (e.g., doppler-shift-related threshold), the WTRU may determine to use a 1^{st} reporting method. If the doppler shift measured by the WTRU is higher than the preconfigured threshold, the WTRU may determine to use a 2^{nd} reporting method.

A reporting method may be based on location. For example, if a WTRU is located in a cell edge, the WTRU may determine to use a 1^{st} reporting method. If the WTRU is in cell center, the WTRU may determine to use a 2^{nd} reporting method. The WTRU may determine if the WTRU is in cell edge or the cell center based on one or more measurements (e.g., average L1-RSRP associated with one or more WTRUs), location estimation (e.g., based on RS measurement based location estimation or location services (e.g., global positioning system (GPS) etc.))

A reporting method may be based on frequency range (FR). For example, if beam predictions are associated with FR1 beams, the WTRU may determine to use a 1^{st} reporting method. If beam predictions are associated with FR2 beams, a WTRU may determine to use 2^{nd} reporting method.

A reporting method may be based on a line of sight (LOS) condition. For example, if a WTRU experiences LOS conditions (within a line of sight), the WTRU may determine to use 1^{st} reporting method. If a WTRU does not have LOS conditions, the WTRU may determine to use 2^{nd} reporting method.

A reporting method may be based on a variation of beam quality (e.g., L1-RSRP) measurements. For example, if the range of beam quality (L1-RSRP) measurements is below or equal to a preconfigured (e.g., via RRC signaling, MAC-CE indication, DCI indication) threshold, a WTRU may determine to use a 1^{st} reporting method. If the range of beam quality (L1-RSRP) measurements exceeds the preconfigured threshold a WTRU may determine to use a 2^{nd} reporting method.

A reporting method may be based on the size of Set A. For example, if the size of set A (e.g., number of RSs/beams in Set A) is smaller than or equal to a preconfigured (e.g., via RRC signaling, MAC-CE indication, DCI indication) threshold, the WTRU may determine to use 1^{st} reporting method. If the size of set A is larger than the preconfigured threshold, the WTRU may determine to use 2^{nd} reporting method.

A reporting method may be based on the size of Set B. For example, if the size of Set B (e.g., number of RSs/beams in Set B) is smaller than or equal to a preconfigured (e.g., via RRC signaling, MAC-CE indication, DCI indication) threshold, the WTRU may determine to use 1^{st} reporting method. If the size of Set B is larger than the preconfigured threshold, the WTRU may determine to use 2^{nd} reporting method.

A reporting method may be based on the accuracy of beam predictions. The accuracy of a beam prediction may be determined by any appropriate method. For example, if the accuracy of the beam predictions (e.g., accuracy of the beam predictions determined by an AI/ML model) is lower than or equal to a preconfigured (e.g., via RRC signaling, MAC-CE indication, DCI indication) threshold, the WTRU may determine to use a 1^{st} reporting method. If the accuracy of the beam predictions is lower than the preconfigured threshold, the WTRU may determine to use a 2^{nd} reporting method.

A WTRU may transmit beam reports based on any of the determined and/or indicated and/or configured method of reporting as described above.

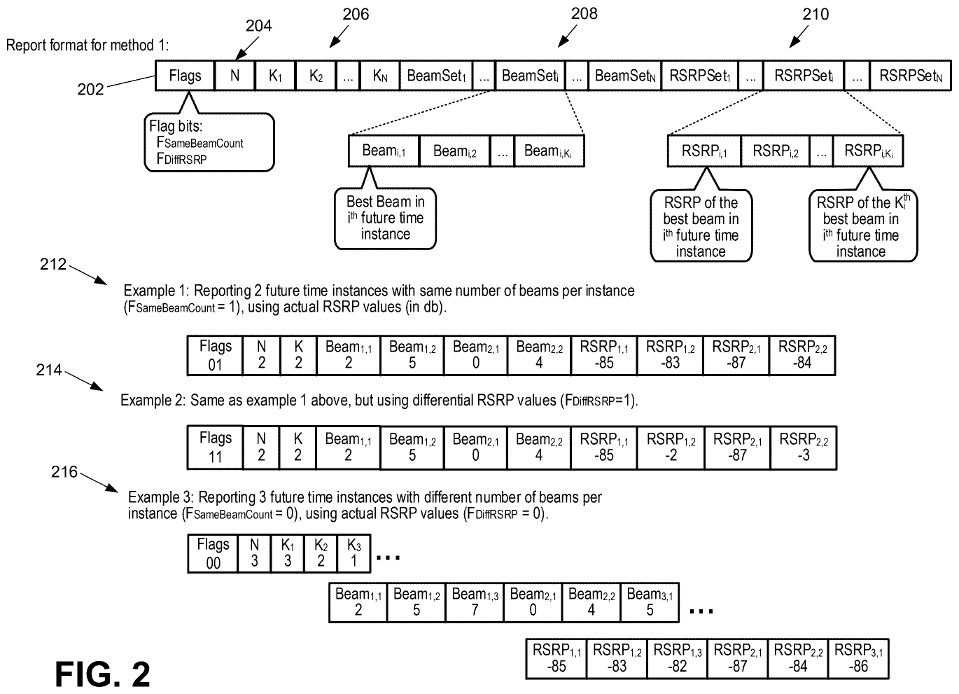

FIG. 2 illustrates an example format of the report that a WTRU may use to report temporally predicted future beams and their reference signal received power (RSRP) values. As depicted in FIG. 2, a WTRU may report one or more of the following. A WTRU may report flags (202) indicating various aspects regarding the report format (F). A WTRU may report the number of future time instances, N (204). A WTRU may report the number of beams (206). A WTRU may report number of beams (208). A WTRU may report RSRP values (210).

FIG. 2 depicts an example reporting for Method 1. A WTRU may report Top-K_n predicted beams and/or RSRPs per time instance (e.g., from the Top-K_max temporally predicted beams and/or RSRPs) for N future instances in one report in a sequence. The WTRU may report the predicted beams for each reporting instance in the order of expected performance (e.g., order of predicted RSRPs). The WTRU may report the K_n values for all N instances.

The WTRU may report flags (202) indicating the report format (F). The WTRU may include one or more flags indicating the format of the report for different scenarios. The Flags, F, may include one or more of the following indicators. A flag may indicate (212) the same number of beams for different future time instances (F_{SameBeamCount}). A flag may indicate (214) whether differential values are used for the RSRPs within sets of RSRP values for future time instances (F_{DiffRSRP}).

The report may indicate (216) the number of future time instances (N). If the number of temporally predicted future time instances in the report, N, is determined by the WTRU, then the WTRU may include this value in the report. The number of temporally predicted future time instances may be determined by the WTRU or indicated/configured by the network node (e.g., gNB) as described above.

The report may indicate the number of beams for all future time instances (K). If the number of beams for all future time instances in the report is the same (K_{SameBeamCount}=1), and if this number is determined by the WTRU, the WTRU may include this value (K) in the report. The number of beams per future time instance may be determined by the WTRU or indicated/configured by a network node (e.g., gNB) as described above.

The report may indicate the number of beams per future time instance (K_n). If different future time instances contain different number of beams (K_{SameBeamCount}=0), and if these numbers of beams are determined by the WTRU, the WTRU may include one value, K_n (n=∈{1, 2, . . . , N}), for each one of N future time instances. The number of beams per future time instance may be determined by the WTRU or indicated/configured by a network node (e.g., gNB) as described above.

The report may indicate N sets of beams one per each future time instance (BeamSetₙ). The WTRU may include N sets of beams in the report where the n^{th} set of beams, BeamSetₙ, contains top-K_n beam indexes for the n^{th} future time instance corresponding to highest RSRP values in the descending order. If the indicator K_{SameBeamCount} is set to 1, all K_n values may be the same and equal to K.

The report may indicate N sets of RSRP values one per each future time instance (RSRPSetᵢ). The WTRU may include N sets of RSRP values in the report where the n^{th} set of RSRP values, RSRPSetₙ, contains top-K_n RSRP values for the n^{th} future time instance in the descending order. If the indicator K_{SameBeamCount} is set to 1, all K_n values may be the same and equal to K. The RSRP values may be formatted based on the value of F_{DiffRSRP} indicator as follows. If the F_{DiffRSRP} indicator is set to 1, then in n^{th} set of RSRP values for the n^{th} future time instance, the actual value of the first RSRP is included in the report followed by K_n−1 differential values for the remaining RSRP values. In other words: ReportedRSRP_{n,j}=RSRP_{i,j}-RSRP_{n,j-1}, (n∈{1, 2, . . . , N} and j∈{2, 3, . . . , Kᵢ}). If the F_{DiffRSRP} indicator is set to 0, then top-Kᵢ RSRP values for the n^{th} future time instance in the descending order are included in the report (e.g., the actual values, not differential values).

In accordance with Method 2, a WTRU may report predicted beams and predicted RSRP values, and indicate the association of reported beams/RSPRs with future instances using bitmaps. The WTRU may report Top-K_n predicted beams and/or RSRPs per time instance (e.g., from the Top-K_max temporally predicted beams and/or RSRPs) for N future instances in a set. The WTRU may report the beams in order of performance/predicted RSRPs. The WTRU may indicate a value of N (e.g., if determined by WTRU). The WTRU may report one or more (e.g., N) bitmap(s) to identify a time instance for each reported predicted beam and/or RSRP. The WTRU may determine M predicted RSRPs to be reported out of all the RSRPs predicted for N future instances. For example, the WTRU may determine a subset of RSRPs out of all the predicted RSRPs across N future instances (1^{st} future instance, 2^{nd} future instance, . . . , Nth future instance) by using one of the beams and/or RSRP determination methods described above, or based on configuration/indication received by the gNB.

A WTRU may determine and report N. A WTRU may determine the value of N based on indication/configuration received from a network node (e.g., gNB). The WTRU may determine the value of N and indicate the determined value of N to the network node (e.g., gNB) as part of beam report. To this end, the WTRU may determine the value of N based on one or more of the following. N may be determined based on the accuracy of RSRP predictions. For example, the WTRU may determine the accuracy of beam predictions (e.g., accuracy of predicted beams for each future instance) by using an AI/ML model. The WTRU may select N such that (N+1)th is the first future instance with lower beam prediction accuracy than a preconfigure (e.g., via RRC signaling, MAC-CE indication, DCI indication) threshold. N may be determined based on the size of Set B (e.g., number of beams in Set B). For example, the WTRU may be configured/indicated (e.g., via RRC signaling, MAC-CE indication, DCI indication) with two values for N (e.g., 1^{st} value, 2^{nd} value) and a threshold on Size of Set B. The WTRU may select a 1^{st} value for N if size of Set B is lower than or equal to the preconfigured threshold. The WTRU may select a 2^{nd} value for N if size of Set B is greater than the preconfigured threshold. N may be determined based on the speed of WTRU. For example, the WTRU may be configured/indicated (e.g., via RRC signaling, MAC-CE indication, DCI indication) with two values for N (e.g., 1^{st} value, 2^{nd} value) and a threshold on speed. A WTRU may select a 1^{st} value for N if the speed of the WTRU is lower than or equal to the preconfigured threshold. A WTRU may select a 2^{nd} value for N if the speed of the WTRU is greater than the preconfigured threshold. N may be determined based on LOS conditions. For example, the WTRU may be configured/indicated (e.g., via RRC signaling, MAC-CE indication, DCI indication) with two values for N (e.g., 1^{st} value, 2^{nd} value). If the WTRU experiences LOS conditions, the WTRU may select the 1^{st} value for N. If the WTRU is not in LOS conditions, the WTRU may the select 2^{nd} value for N.

A WTRU may report RSRP values, beam IDs, and the association of reported beams with future instances. A WTRU may report M RSRPs (denoted by RSRP₁, RSRP₂, RSRP₃, . . . , RSRP_{M}), beam indices associated with each of the RSRP (denoted by beamIndex₁, beamIndex₂, beamIndex₃, . . . , beamIndex_{M}) (in the case RSRPₖ and RSRPₘ associate with the same beam, beamIndexₖ=beamIndexₘ), and future instance (i.e., 1^{st} future instance, or 2^{nd} future instance, . . . , or Nth future instance) for each of the RSRP associated with the network node (e.g., gNB). For example, a WTRU may report (e.g., via PUCCH, PUSCH) M RSRPs, beam indices associated with each RSRP, and future instance for each RSRP associated with in a single beam report. The WTRU may indicate the value of N (e.g., if determined by WTRU). The WTRU may indicate beams for each instance via bitmap(s). To this end, the WTRU may perform one or a combination of the following steps/procedures. The WTRU may order (e.g., ascending order or descending order) M RSRPs determined to be reported based on their RSRP values. In the case two or more RSRPs are equal, the WTRU may order RSRPs based on a preconfigured procedure (e.g., preconfigured by RRC signaling, MAC-CE indication, DCI indication) or a procedure known by both the WTRU and the network node (e.g., gNB). For example, in the case two or more RSRPs are equal, a WTRU may order RSRPs first based on beam indices associated with the RSRPs and second (in the case two or more equal RSRPs are associated with the same beam) based on future instance RSRPs are associated with (i.e., 1^{st} future instance, 2^{nd} future instance, . . . , Nth future instance).

A WTRU may report (e.g., via PUCCH, PUSCH) ordered M RSRPs (denoted by RSRP⁽¹⁾, RSRP⁽²⁾, RSRP⁽³⁾, . . . , RSRP^{(M)}) to the gNB. For example, the WTRU may report ordered M RSRPs as a bit sequence of the form of {RSRPblock(1), RSRPblock(2), RSRPblock(3), . . . , RSRPblock(M)}, where RSRPblock(m) represents RSRP^{(m)}. The WTRU may report (e.g., via PUCCH, PUSCH) beam indices (denoted by beamIndex⁽¹⁾, beamIndex⁽²⁾, beamIndex⁽³⁾, beamIndex^{(M)}) associated reported M RSRPs. Here beamIndex⁽¹⁾ is the index of a beam associated with RSRP⁽¹⁾, beamIndex⁽²⁾ is the index of the beam associated with RSRP⁽²⁾, and so forth. For example, the WTRU may report beam indices in a bit sequence of the form of {beamIndexblock(1), beamIndexblock(2), . . . , beamIndexblock(M)} where beamIndexblock(m) represents beamIndex^{(m)}. A WTRU may report (e.g., via PUCCH, PUSCH) the association of reported M RSRPs and beam indices with N future instances in the form of N bit maps (bitmap₁, bitmap₂, . . . , bitmap_{N}) where each bitmap consists of M bits. Each bitmap may associate with a future instance. For example, bitmap₁ may be associated with 1^{st} future instance. Bitmap₂ may associate with 2nd future instance and so forth. Each bit in a bitmap may associate a reported RSRP and beam index. For example, the 1^{st} bit in bitmap₁ may associate RSRP⁽¹⁾ with beamIndex⁽¹⁾, 2^{nd} bit in bitmap₁ may associate with RSRP⁽²⁾ and beamIndex⁽²⁾, and so forth. Similarly, a 1^{st} bit in bitmap₂ may associate with RSRP⁽¹⁾ and beamIndex⁽¹⁾, 2^{nd} bit in bitmap₂ may associate with RSRP⁽²⁾ and beamIndex⁽²⁾, and so forth. For example, if reported RSRP^{(m)} associate with nth future instance, the WTRU may report bitmapₙ with mth bit (e.g., mth most significant bit (MSB)) set to 1^{st} value (e.g., 1). If reported RSRP^{(m)} does not associate with nth future instance, a WTRU may report bitmapₙ with mth bit (e.g., mth MSB bit) set to 2^{nd} value (e.g., 0).

Special predicted beam sets and corresponding temporally predicted RSRPs may be reported. A WTRU may report one or more of a set of beams, measured RSRP values for a set of selected/determined beams, predicted RSRP values for a set of selected/determined beams, or the like, or any appropriate combination thereof.

A WTRU may select a set of beams from one or more of Set A beams (potentially precluding Set B beams), Set B beams, and/or all configured beams. The selection may be based on measured/predicted RSRPs. For example, the WTRU may select the best N1 and/or worst N2 beams which satisfy predefined/preconfigured conditions. A condition of the predefined/preconfigured conditions may be whether one or more measured/predicted RSRPs are larger than or equal to a threshold. The one or more measured/predicted RSRPs may be one or more of an average of predicted RSRPs of a beam across multiple future time instances, a predicted RSRP of a beam associated with each time instance, and/or a weighted average of predicted RSRP values across multiple future time instances.

Regarding the average of predicted RSRPs of a beam across multiple future time instances, a WTRU may indicate a beam if the average of predicted RSRPs of the beam across multiple future time instances>the threshold.

Regarding predicted RSRPs of a beam associated to each time instance, a WTRU may indicate a beam if predicted RSRP of the beam for each time instance>the threshold. If multiple time instances are used, then the WTRU may report the beam if a number of instances which satisfy the threshold>a time instance threshold, then the WTRU may report the beam. The time instance threshold may be one of 1, a configured/indicated number (e.g., from a gNB), number of instances and etc. The time instance threshold may be predefined or indicated via one or more of RRC, MAC CE and DCI.

Regarding a weighted average of predicted RSRPs of a beam across multiple future time instances, a WTRU may indicate a beam based on the weighted average of predicted RSRPs of beams across multiple future time instances. For example, a weighted average RSRP may be RSRP_weighted=c1*RSRP1+c2*RSRP2+ . . . +cn*RSRPn. Where, c1+ . . . +cn may be 1. The coefficients c1, . . . , cn may be predefined (e.g., a function of number of future instances) or configured/indicated by the gNB (e.g., via one or more RRC, MAC CE and DCI).

A WTRU may determine one or more beams to be reported if a number of beams satisfies the condition>a maximum number of beams to be reported. For example, the WTRU may be configured/indicated with the maximum number of beams to be reported. In another example, the maximum number of beams to be reported may be predefined. If the number of beams satisfy the condition>the maximum number of beams to be reported, then the WTRU may select one or more beams from the beams which satisfy the condition. The selection may be based on one or more of measured RSRPs and/or predicted RSRPs. For example, the WTRU may select best N1 and/or worst N2 beams among the beams which satisfy the condition. The measured RSRPs and/or the predicted RSRPs may be average RSRP, weighted RSRP, measured RSRP (e.g., corresponding to CSI reporting instance), predicted RSRP and etc.

A WTRU may determine a subset of beams for each time instance. For example, the WTRU may determine a first subset of beams for a first time instance, a second subset of beams for a second time instance and etc. The set of beam may indicate all the determined subsets of beams. A WTRU may indicate the set of beams. The indication may be based on one or more of CRIs, SSBRIs, logical beam indexes, CSI-RS resource set index, beam pattern index, logical beam set index and etc.

A WTRU may indicate measured RSRPs for a set of selected/determined beams. A WTRU may indicate measured RSRPs corresponding to the set of predicted beams. For example, a WTRU may indicate measured RSRP for each beam of the set of selected beams. A WTRU may use L1-RSRP (e.g., 7 bits) and differential L1-RSRP (e.g., 4 bits) to indicate measured RSRPs for the set of selected beams. For example, L1-RSRP may be defined from −140 dBm to −40 dBm with 1 dB resolution. For example, differential L1-RSRP may be defined from 0 dBm to −30 dBm with 2 dB resolution (e.g., with non-positive values).

A WTRU may indicate predicted RSRPs for the set of selected beams A WTRU may indicate predicted RSRPs corresponding to the set of predicted beams. The WTRU may indicate predicted RSRPs based on one or more of the following. A WTRU may indicate predicted RSRP for each beam of the set of selected beams. A WTRU may indicate average predicted RSRP and/or weighted average predicted RSRP for each beam or for the set of selected beams. For example, a WTRU may indicate a predicted RSRP value for each beam in multiple time instances. For example, a WTRU may indicate a predicted RSRP value for the set of selected beams in multiple time instances.

A WTRU may indicate a flag. For example, if predicted RSRP or differential RSRP>a threshold, the WTRU may indicate 1. For example, if predicted RSRP or differential RSRP>a threshold, the WTRU may toggle an indication (e.g., if 0 is previously indicated, then the WTRU may indicate 1). Otherwise, the WTRU may indicate the previous indication (e.g., if 0 is previously indicated, then the WTRU may indicate 0). The indication may be for each beam or the set of selected beams (e.g., based on average or weighted average.

WTRU may use predicted RSRP (e.g., 6 bits) and differential predicted RSRP (e.g., 5 bits) to indicate measured RSRPs for the set of selected beams. For example, predicted RSRP may be defined from −140 dBm to −40 dBm with 2 dB resolution. For example, differential predicted RSRP may be defined from 30 dBm to −30 dBm with 2 dB resolution.

A reference of the differential predicted RSRP for each beam and each time instance may be based on one or more of predicted RSRP of a best beam, measured RSRP of a best beam, predicted RSRP for each beam in a first time instance, predicted RSRP for each beam in a previous time instance, or the like, or any appropriate combination thereof.

The best beam may be a beam among the set of selected/determined beams with one or more of the following: a beam with a firstly reported beam index (e.g., CRI, SSBRI or logical beam index); a beam with best measured RSRP value; and/or a beam with best predicted RSRP value (e.g., with one or more of average predicted RSRP, weighted average predicted RSRP and predicted RSRP for each time instance).

The indication may be for one instance or for multiple instances. For example, the WTRU may indicate one predicted RSRP value for multiple future time instances. For example, the WTRU may indicate predicted RSRP values for multiple future time instances wherein each predicted RSRP value is associated with each future time instance.

A combination of spatially and temporally predicted beams and RSRP values may be reported. A WTRU may be configured, and/or indicated to report one or more predicted beam resources and/or corresponding predicted quality parameters based on a combination of spatially and temporally predictions. For example, a WTRU may report spatially predicted beams and/or RSRPs in a first instance in addition to reporting temporally predicted beams and/or RSRPs for one or more future time instances. A WTRU may receive one or more configuration information for reporting the combined report, for example via RRC, MAC-CE, DCI, etc. In an example, the WTRU may report one or more predicted quality parameters, including for example RSRP, RSSI, RSRQ, etc.

A WTRU may receive one or more threshold values on spatially and/or temporally predicted beams and/or quality parameters, based on which the WTRU may determine to perform combined reporting and one or more corresponding configurations. For example, a WTRU may receive one or more threshold values, for example via RRC, MAC-CE, DCI, etc. One or more of the following may apply. Only spatially predicted beams and/or RSRPs may be reported. For example, a WTRU may determine to report only spatially predicted beams and/or RSRPs, if the predicted RSRPs for the corresponding predicted beams is higher than a first RSRP threshold; the WTRU may determine to report only spatially predicted beams and/or RSRPs, if the accuracy of predicted beams and/or RSRPs is higher than a first accuracy threshold, and so forth. Combined spatially and temporally predicted beams and/or RSRPs may be reported. For example, a WTRU may determine to report combined spatially and temporally predicted beams and/or RSRPs, if the predicted RSRPs for the corresponding predicted beams is lower than the first RSRP threshold and higher than a second RSRP threshold; the WTRU may determine to report combined spatially and temporally predicted beams and/or RSRPs, if the accuracy of predicted beams and/or RSRPs is lower than the first accuracy threshold and higher than a second accuracy threshold, and so forth.

Regarding configuration on reporting combined spatially and temporally predicted beams and RSRP values, a WTRU may determine and/or receive one or more configuration information on reporting combined spatially and temporally predicted beams and RSRPs. One or more of the following configurations may apply. Periodicity to send combined reports may be configured. For example, a WTRU may determine, be configured, and/or indicated with the time period and/or frequency to report the combined predicted beams and/or RSRPs. Time instances to report spatially and/or temporally predicted beams and/or RSRPs may be configured. For example, a WTRU may determine, be configured, and/or indicated with a first set of time instances for which the WTRU may report the spatially predicted beams and/or RSRPs. In another example, the WTRU may be configured and/or indicated with a second set of time instances for which the WTRU may report the temporally predicted beams and/or RSRPs.

The temporally predicting set of time instances may be configured, indicated, and/or determined based on exact time values. The temporally predicting set of time instances may be configured, indicated, and/or determined based on the spatially predicting set of time instances. That is, for example, a WTRU may report the spatially predicted beams and/or RSRPs at the spatially predicting time instances in addition to temporally predicted beams and/or RSRPs in the temporally predicting time instances following the temporally predicting time instance.

A WTRU may determine the temporally predicting time occasions based on the first spatially predicting time occasion in addition to one or more determined, configured, and/or indicated starting time, time gap and/or time offset, maximum number of temporally predicting time occasions, etc. A WTRU may determine a first temporally predicting time occasion to start after a time duration from a first spatially predicting time occasion. A WTRU may determine the next temporally predicting time occasions based on a time gap from the first temporally predicting time occasion for a number of temporally predicting time occasions. For example, a WTRU may determine the first temporally predicting time occasions to start from S1 (e.g., S1=K) symbols, slots, frames, etc. after the spatially prediction report, and the next temporally predicting time occasions to be S2 (e.g., S2=M) symbols, slots, frames, etc. after the first temporally predicting time occasion for N times.

A WTRU may determine a first temporally predicting time occasion to start after a time duration from a first spatially predicting time occasion. A WTRU may determine the next temporally predicting time occasions based on a time gap from the first temporally predicting time occasion until the next spatially predicting time occasions. For example, a WTRU may determine the first temporally predicting time occasions to start from S1 symbols, slots, frames, etc. after the spatially prediction report, and the next temporally predicting time occasions to be S2 symbols, slots, frames, etc. after the first temporally predicting time occasion until the next spatially prediction report.

A correction report may be transmitted. A WTRU may report the results based on comparing and the differences between one or more measured quality parameters with respective predicted parameters. A WTRU may compare one or more measured quality parameters with respective predicted parameters, for example, to determine the accuracy or validity of beam and/or quality parameters' prediction. A WTRU may determine the validity or accuracy of one or more predicted beams and/or quality parameters. A WTRU may be configured with resources on which to perform measurements to determine the validity of predicted beams and/or quality parameters. For example, a WTRU may determine the prediction validity based on a measurement of a quality parameters, for example performed on one or more reference signals (RS). The measurements may include at least one of: RSRP, RSSI, RSRQ, CQI, etc. In an example, the WTRU may determine to not transmit the report if the predicted (best and/or Top-1) beam, for example with the highest predicted RSRP, remains the same, despite that the determined difference between the predictions and measurements may be higher than a corresponding threshold. A WTRU may determine, be configured, and/or indicated (e.g., via RRC, MAC-CE, DCI, etc.) to report the results based on one or more of the following.

A WTRU may determine, be configured, and/or be indicated (e.g., via RRC, MAC-CE, DCI, etc.) to report the results based on a request for CSI report. For example, a WTRU may send a request to get grants for one or more CSI report transmission. A WTRU may send a scheduling request (SR), for example to a gNB, to request for UL resource grants for CSI reporting. A WTRU may indicate the request for CSI reporting via a flag indication as part of the transmitted SR. A WTRU may send a special SR, for example, in specifically configured resources to indicate the request for UL grant for CSI report transmission. A WTRU may request granted UL resources to transmit aperiodic CSI report.

A WTRU may determine, be configured, and/or be indicated (e.g., via RRC, MAC-CE, DCI, etc.) to report the results based on a request for retransmission of measuring RSs. A WTRU may send a request to receive the (re) transmission of one or more measurement RSs. A WTRU may send a request to receive the (re) transmission on of one or more Set B beam resources. A WTRU may send an SR, for example to a network node (e.g., gNB), to request for (re) transmission of the RSs. A WTRU may indicate the request for (re) transmission of the RSs via a flag indication as part of the transmitted SR. A WTRU may send a special SR, for example, in specifically configured resources to indicate the request for (re) transmission of the RSs.

A WTRU may determine, be configured, and/or be indicated (e.g., via RRC, MAC-CE, DCI, etc.) to report the results based on a one-shot short report transmission. A WTRU may transmit a short report, for example via a one-shot (e.g., small report) indication, for example to indicate a correction report. A WTRU may send an SR, for example, to a network node (e.g., gNB), to transmit the determined short one-shot report. A WTRU may indicate the one-shot short report as part of the transmitted SR. A WTRU may send a special SR, for example, in specifically configured resources including the one-shot short report. A WTRU may indicate one or more indications as part of the one-shot report, where, for example, one or more of the following may apply.

A Top-1 temporally or spatially predicted beam and/or RSRP may appley. A WTRU may report the predicted beam and associated predicted RSRP for the (best) beam, for example with the highest predicted RSRP. A WTRU may report the (best) beam based on temporally prediction or spatially prediction. As such, the WTRU may indicate, for example, via a flag indication, if the reported predicted beam is based on temporally or spatially prediction. In case the WTRU reports the temporally predicted beam and/or RSRP, the WTRU may report a determined, configured, and/or indicated number of (future) time instances for the temporally predicted beam and/or RSRP. A WTRU may determine the number of time instances for reporting the temporally predicted beam and/RSRP based on the time duration that has passed since the previous reporting.

Prediction accuracy may apply. For example, a WTRU may transmit periodic one-shot short reports to indicate the accuracy of beam and/or RSRP prediction. That is, the WTRU may transmit periodic one-shot short reports to indicate the status of prediction quality. A WTRU may transmit the periodic report after a (pre) configured and/or determined number of time instances has elapsed since the last reporting. For example, a WTRU may transmit the report after 5 time instances if the reporting period takes 10 time instances.

Measurements and reporting parameters may apply. For example, a WTRU may send a report including suggestions on preferred parameters for measurement and reporting. A WTRU may suggest preferred N and K values. For example, a WTRU may determine the preferred parameters based on measurements and comparing the measurement results with predicted results. A WTRU may determine the preferred parameters based on the number of instances for which the difference between measured and predicted RSRP of the predicted (best and/or Top-1) beam is lower than a corresponding threshold. A WTRU may report the determined number of instances. A WTRU may determine the preferred parameters based on the number of beams for which the difference measured and predicted RSRP is lower than a corresponding threshold, for example for each instance. A WTRU may report the determined number of beams.

Beam information may be reported. A WTRU may report information for measured/predicted RSRPs for multiple time instances in report having a single part or multiple parts. A WTRU may report information for measured/predicted RSRPs for multiple time instances based on one or more of the following. In accordance with 1 part reporting, a WTRU may indicate all the information including reporting method, number of time instances, number of beams (e.g., one value for all time instances or multiple values wherein each value corresponding to each time instance), CRIs/SSBRIs, measured L1-RSRPs/differential L1-RSRPs and predicted L1-RSRPs/differential L1-RSRPs. In this case, the WTRU may determine a total payload size for the reporting by assuming maximum size. For example, if the number of instances in the report<maximum number of instances in a report (e.g., configured/indicated by a gNB e.g., via one or more of RRC, MAC CE and DCI), the WTRU may identify payload size of the reporting as number of bits for each time instance*maximum number of time instances. In another example, if the number of beams in a time instance of the reporting<maximum number of beams in a time instance of a report (e.g., configured/indicated by a network node (e.g., gNB, via one or more of RRC, MAC CE and DCI), the WTRU may identify payload size for beam related information of the a time instance as number of bits for one beam for a time instance*number of bits for maximum number of beams for a time instance. If actual information size is less than the payload size, the WTRU may use padding of bits. For example, fixed bits (e.g., zeros) may be padded in the front of one or more of the whole information. For example, when 2 time instances are reported while 4 maximum time instances are configured/indicated, the WTRU may include 0s in the front/last of the reporting for 2 time instances which are not reported. In another example, the WTRU may include 0s in the front/last of the reporting for each instance if number of beams in each time instance is less than a maximum number of beams.

In accordance with 2 part reporting, a WTRU may indicate first information group in a first part and second information group in a second part. The first part information may determine a payload size for the second information group. The 2 part reporting may be based on one or more of the following. For example, the first part may indicate a reporting method (e.g., one or more of method 1, 2, 3, and 4) and the second part may indicate beam information based on the indicated reporting method. The first part may indicate a number of time instances and the second part may indicate beam information associated with the indicated number of time instances. The first part may indicate number of beams (e.g., one value for all time instances or multiple values wherein each value corresponding to each time instance) and the second part may indicate beam information associated with the indicated number of beams.

In accordance with 3 part reporting, a WTRU may indicate a first information group in a first part, a second information group in a second part, and a third information group in a third part. The first part information may determine a payload size for the second information group. The second part information may determine a payload size for the third information group. The 3 part reporting may be based on one or more of the following. The first part may indicate a reporting method, the second part may indicate number of time instances, and the third part may indicate beam information associated with the reporting method and the number of time instances. The first part may indicate a reporting method, the second part may indicate number of beams (e.g., one value for all time instances or multiple values wherein each value corresponding to each time instance), and the third part may indicate beam information associated with the reporting method and the number of beams. The first part may indicate number of instances, the second part may indicate number of beams (e.g., one value for all time instances or multiple values wherein each value corresponding to each time instance) and the third part may indicate beam information associated with the number of instances and the number of beams. Beam information may include one or more of CRI, SSBRI, RI, L1, PMI, L1-RSRP, L1-SINR, CQI and etc.

A WTRU may determine a reporting structure (e.g., one of 1 part reporting, 2 part reporting, or 3 part reporting) and corresponding beam information based on a determined reporting method. For example, a WTRU may use a first reporting structure (e.g., 2 part reporting), if the WTRU is indicating a first reporting method. A WTRU may use a second reporting structure (e.g., 3 part reporting), if the WTRU is indicating a second reporting method.

A WTRU may determine a reporting structure (e.g., one of 1 part reporting, 2 part reporting and 3 part reporting) and corresponding beam information based on configuration/activation of reporting method indication. For example, a WTRU may use a first reporting structure (e.g., 2 part reporting), if the WTRU is not configured/activated with reporting method indication. A WTRU may use a second reporting structure (e.g., 3 part reporting), if the WTRU is configured/activated with reporting method indication.

In an example method for reporting predicted RSRPs, a WTRU may receive a configuration for RSs associated with a measurement set, a prediction set, and WTRU reporting. Based on RS measurements, the WTRU may temporally predict beams and RSRPs. The WTRU may determine reporting parameters (e.g., number of prediction instances, number of beams/RSRPs) based on the received configuration, predicted RSRPs, WTRU measurements and thresholds. The WTRU may select a method for reporting based on received configuration and WTRU measurements. The WTRU may report predicted beams and RSRPs for multiple prediction instances using the selected method and determined report parameters.

For example, a WTRU may receive a configuration comprising one or more of the following. The WTRU may receive a configuration comprising one RS resource set containing RS resource configurations for both Set A and Set B. The WTRU may receive a configuration comprising an indication of Set A/Set B resource through an RS resource configuration. The WTRU may receive a configuration comprising two or more RS resource sets associated with Set A and Set B(s). The WTRU may receive a configuration comprising thresholds (e.g., a threshold for number of beams, an RSRP threshold, RSRP difference threshold, a threshold for WTRU speed, a threshold for LOS probability). The WTRU may receive a configuration comprising a report configuration. The report configuration may comprise a maximum payload size (M), a number of future time instances (N), a number of beams (K), a time configuration (e.g., time gap in temporal predictions reported in a WTRU report), or the like, or any appropriate combination thereof.

The WTRU may perform measurements on RSs associated with Set B and/or Set A. The WTRU may determine the measured beam qualities (e.g., RSRP, SINR, noise power) based on RS measurements. The WTRU may predict one or more of the following based on RS measurements associated with Set B. Based on RS measurements associated with Set B, the WTRU may predict the Top-K_max spatially predicted beams and/or RSRPs (e.g., where Top-K_max spatially predicted beams are the K_max spatially predicted beams in Set A with highest predicted RSRP values in a first time instance). Based on RS measurements associated with Set B, the WTRU may predict the Top-K_max temporally predicted beams and/or RSRPs for one or more future time instances (e.g., for one or more slots/frames etc.) (e.g., where Top-K_max temporally predicted beams are the K_max temporally predicted beams in Set A with highest predicted RSRP value in one or more future time instances).

The WTRU may determine a value of N and a number of beams per time instance, denoted by K_n (where n=1, 2, . . . . N) based on the received configurations and thresholds (e.g., K_n is equal to Number of predicted RSRPs>RSRP threshold per time instance n, and the value of K_n is upper bounded by M/N and K_max, and N is received in configuration).

The WTRU may select/determine a reporting method based on, for example, measurements, determined values of N and K_n, and thresholds. In a first method (Method 1), the WTRU may report Top-K_n predicted beams and/or RSRPs per time instance (e.g., from the Top-K_max temporally predicted beams and/or RSRPs) for N future instances in one report in a sequence. The WTRU may report the predicted beams for each reporting instance in the order of expected performance (e.g., order of predicted RSRPs). The WTRU may report the K_n values. The total number of beams reported may be equal to the sum of Top-K_n over all N.

In a second reporting method (Method 2), The WTRU reports Top-K_n predicted beams and/or RSRPs per time instance (e.g., from the Top-K_max temporally predicted beams and/or RSRPs) for N future instances in a set. The WTRU may report the beams in order of performance/predicted RSRPs. The WTRU may indicate a value of N (e.g., If determined by WTRU). The WTRU may report one or more (e.g., N) bitmap(s) to identify a time instance for each reported predicted beam and/or RSRP.

In a third reporting method (Method 3), the WTRU may select a single set of K_n (e.g., n=1) predicted beams to report applicable to every N future time instance based on predicted RSRPs of beams (e.g., average, weighted and/or instantaneous predicted RSRP). The WTRU may indicate a selected set of K_n predicted beams to the gNB and predicted RSRPs associated to reported beams.

In a fourth reporting method (Method 4), the WTRU may report the best (e.g., Top-1) beam(s) for each time instance. The WTRU may report the predicted RSRP (e.g., absolute) of the Top-1 beam for the first time instance. The WTRU may report differential (i.e., both positive and negative) predicted RSRPs associated to reported beams for the subsequent N−1 time instances.

The WTRU may provide a spatial and temporal combined report. The WTRU may report Top-K_1 spatially predicted beams and/or RSRPs in the first time instance. The WTRU may report Top-K_n temporally predicted beams and/or RSRPs for the remaining/other N−1 time instances.

The WTRU may report feedback using the selected reporting method. The WTRU may indicate the selected reporting method and/or measurements used to select the reporting method.

In accordance with the above-described method, a WTRU may be enabled to support reporting mechanisms for temporal beam and beam quality predictions made by the WTRU. Moreover, beam configuration latency at the network may be reduced, because the network may obtain information on future beams in advance in a single report.

A WTRU may provide/transmit a correction report. Based on the difference between reported predicted RSRP and measured RSRP of beams, the WTRU may trigger/transmit one or more of the following on a configured reserved resource. The WTRU may trigger/transmit a transmission of a small correction report on reserved resources (e.g., small report). The WTRU may indicate a Top-1 temporally or spatially predicted beam and/or associated predicted RSRP and sends a flag indication indicating the type of prediction (i.e., spatial or temporal). The number of future instances may be a function of the amount of time passed after previous report. The WTRU may trigger/transmit periodically with a short period correction report indicating the status of prediction quality (e.g., after 5 instances for a 10-instance reporting). Optionally, the WTRU trigger/transmit if the Top-1 beam remains the same even if RSRP difference is >threshold. The WTRU may indicate a preferred N and K value based on measurements. The WTRU may indicates the number of instances for which RSRP difference b/w measured and predicted of Top-1<threshold. The WTRU may indicate the number of beams for which RSRP difference b/w measured and predicted<threshold for each instance. The WTRU may trigger/transmit a request (e.g. 1-bit flag) for resources for a full aperiodic CSI report. The WTRU may trigger/transmit a request for re-transmission (e.g., 1-bit flag) of RSs.

1. A wireless transmit/receive unit (WTRU) comprising:
a transceiver; and
a processor configured to:
receive, via the transceiver, configuration information, wherein the configuration information comprises:
an indication of a first set of beams;
an indication of a second set of beams, wherein the second set of beams is a subset of the first set of beams;
an indication of a set of RS resources associated with the second set of beams; and
an indication of one or more beam quality thresholds;
determine a measured beam quality associated with at least one beam of the second set of beams based on measurements performed on the set of RS resources associated with the second set of beams;
determine, for at least one future time instance, a predicted beam quality associated with at least one beam of the first set of beams based on the measured beam quality associated with the at least one beam of the second set of beams; and
send, via the transceiver, a report, wherein content of the report is based on the predicted beam quality associated with the at least one beam of the first set of beams for the at least one future time instance and the received one or more beam quality thresholds.

2. The WTRU of claim 1, wherein the measured beam quality associated with the at least one beam of the second set of beams is associated with a first time instance and the predicted beam quality associated with the at least one beam of the first set of beams is associated a future time instance the is subsequent in time to the first time instance.

3. The WTRU of claim 1, wherein the measured beam quality associated with the at least one beam of the second set of beams comprises at least one of reference signal received power (RSRP), signal to interference plus noise ratio (SINR), or noise power, and wherein the predicted beam quality associated with the at least one beam of the first set of beams comprises at least one of reference signal received power (RSRP), signal to interference plus noise ratio (SINR), or noise power.

4. The WTRU of claim 1, wherein the content of the report comprises, for each future time instance of the at least one future time instance, an indication of selected beams of the first set of beams, wherein the selected beams associated with each future time instance are indicated for each future time instance in a sequence of future time instances, and wherein the selected beams are selected based on the predicted beam quality associated with each beam of the first set of beams and the one or more beam quality thresholds.

5. The WTRU of claim 4, wherein the content of the report further comprises an indication of the predicted beam quality associated with each selected beam.

6. The WTRU of claim 1, wherein the content of the report comprises, for each future time instance of the at least one future time instance, an indication of selected beams of the first set of beams, wherein the selected beams are indicated in order of beam quality associated with the selected beams, and wherein the selected beams are selected based on the predicted beam quality associated with each beam of the first set of beams and the one or more beam quality thresholds.

7. The WTRU of claim 6, wherein the content of the report further comprises an indication of the predicted beam quality associated with each selected beam of the first set of beams.

8. The WTRU of claim 6, wherein the report comprises a bitmap for identifying an association between each future time instance and each selected beams of the first set of beams.

9. The WTRU of claim 1, wherein the content of the report comprises, for each future time instance of the at least one future time instance, an indication of a selected beam associated with each future time instance, wherein the selected beams are selected based on the predicted beam quality associated with each beam of the first set of beams and the one or more beam quality thresholds.

10. The WTRU of claim 9, wherein the content of the report further comprises an indication of the predicted beam quality associated with each selected beam.

11. The WTRU of claim 1, wherein the content of the report comprises:
for a first future time instance of the at least one future time instance, an indication of a selected beam of the first set of beams and an indication of the predicted beam quality associated with the selected beam; and
for each future time instance other than the first future instance, an indication of a difference between the predicted beam quality associated with the selected beam for the first future time instance and the predicted beam quality associated with the selected beam associated with each respective other future time instance.

12. The WTRU of claim 1, wherein the content of the report comprises:
an indication of a first beam of the first set of beams; and
for each future time instance of the at least one future time instance, an indication of selected beams of the first set of beams.

13. A method performed by a wireless transmit/receive unit (WTRU), the method comprising:
receiving configuration information, wherein the configuration information comprises:
an indication of a first set of beams;
an indication of a second set of beams, wherein the second set of beams is a subset of the first set of beams;
an indication of a set of RS resources associated with the second set of beams; and
an indication of one or more beam quality thresholds;
determining a measured beam quality associated with at least one beam of the second set of beams based on measurements performed on the set of RS resources associated with the second set of beams;
determining, for at least one future time instance, a predicted beam quality associated with at least one beam of the first set of beams based on the measured beam quality associated with the at least one beam of the second set of beams; and
sending a report, wherein content of the report is based on the predicted beam quality associated with the at least one beam of the first set of beams for the at least one future time instance and the received one or more beam quality thresholds.

14. The method of claim 13, wherein the measured beam quality associated with the at least one beam of the second set of beams is associated with a first time instance and the predicted beam quality associated with the at least one beam of the first set of beams is associated a future time instance the is subsequent in time to the first time instance.

15. The method of claim 13, wherein the content of the report comprises, for each future time instance of the at least one future time instance, an indication of selected beams of the first set of beams, wherein the selected beams associated with each future time instance are indicated for each future time instance in a sequence of future time instances, and wherein the selected beams are selected based on the predicted beam quality associated with each beam of the first set of beams and the one or more beam quality thresholds.

16. The method of claim 13, wherein the content of the report comprises, for each future time instance of the at least one future time instance, an indication of selected beams of the first set of beams, wherein the selected beams are indicated in order of beam quality associated with the selected beams, and wherein the selected beams are selected based on the predicted beam quality associated with each beam of the first set of beams and the one or more beam quality thresholds.

17. The method of claim 16, wherein the report comprises a bitmap for identifying an association between each future time instance and each selected beams of the first set of beams.

18. The method of claim 13, wherein the content of the report comprises, for each future time instance of the at least one future time instance, an indication of a selected beam associated with each future time instance, wherein the selected beams are selected based on the predicted beam quality associated with each beam of the first set of beams and the one or more beam quality thresholds.

19. The method of claim 13, wherein the content of the report comprises:
for a first future time instance of the at least one future time instance, an indication of a selected beam of the first set of beams and an indication of the predicted beam quality associated with the selected beam; and
for each future time instance other than the first future instance, an indication of a difference between the predicted beam quality associated with the selected beam for the first future time instance and the predicted beam quality associated with the selected beam associated with each respective other future time instance.

20. The method of claim 13, wherein the content of the report comprises:
an indication of a first beam of the first set of beams; and
for each future time instance of the at least one future time instance, an indication of selected beams of the first set of beams.
